(19) United States
(12) Patent Application Publication
(10) Pub. No.: US 2008/0136121 A1
(43) Pub. Date: Jun. 12, 2008

(54) Sealing Arrangement

(75) Inventor: Paavo Zelazo, Marienhagen (DE)

Correspondence Address: SYNNESTVEDT & LECHNER, LLP, 1101 MARKET STREET, 26TH FLOOR, PHILADELPHIA, PA, 19107-2950, US

(73) Assignee: METEOR GUMMIWERKE K. H. BÄDJE GMBH & CO. KG, Bockenem (DE)

(21) Appl. No.: 11/908,448

(22) PCT Filed: Dec. 21, 2005
(86) PCT No.: PCT/EP2005/013751

§ 371 Date: Sep. 12, 2007

(30) Foreign Application Priority Data
Mar. 12, 2005 (DE) 20 2005 004 005.3

(51) Int. Cl. B60J 10/00; B60J 10/08

(52) U.S. Cl. 277/630

(57) ABSTRACT

In order to easily permit functionally correct mounting of a sealing strip (3) which is intended for use on the frame structure of a vehicle opening, a sealing arrangement is proposed which is composed of an attachment section (4) and a sealing section (5), wherein aids are provided which are intended for carrying out uniquely determined positioning on a section (2) of the aforesaid frame structure. These aids are a groove (7) which is configured to receive a frame part of the frame structure and which extends along the entire length of the sealing strip (3) and whose maximum insertion depth signals the precise positioning of the sealing strip on the aforesaid frame part. These aids can also be a bead (15) which is integrally formed on the attachment section (4) and which performs the function of a spacing element in relation to a stop surface of the aforesaid frame structure and is connected to the attachment section in a releasable, in particular tear-off connection. Such a sealing arrangement can be mounted easily and quickly, in particular under service conditions.

The invention relates to a sealing arrangement corresponding to the preamble of claim 1.

Such sealing arrangements are known in a variety of forms at the applicant's company. They are generally composed of a sealing strip which is either attached to the edge of a vehicle opening or to the door boundary which interacts with said opening, and is arranged with the stipulation that a sealing function can be performed in the closed state of the door. For this purpose, the sealing strip has an attachment section which is configured for direct connection to the aforesaid edge, wherein a sealing section which bears in a seal-forming fashion against the respective corresponding profile of the edge in the closed state of the door is arranged on the attachment section.

During the closed state of the door, the sealing section is subject to elastic deformation by means of which the necessary sealing force is applied, which sealing force should be provided uniformly along the entire periphery of the door.

Such sealing arrangements are known, for example, from documents WO 02 085 657 A1 and EP 0 415 005 A2. The latter have a groove or a comparable recess by means of which the sealing arrangement can be plugged onto a free end of a frame part of the frame structure of the vehicle opening.

A section of the frame structure which is intended to produce a bonding connection is frequently used to mount the sealing strip, in particular its attachment section, the entire position on this section being dependent on the individual structure of the door, in particular also the corresponding profiles lying opposite, for example of a door boundary. The sealing strips are usually mounted at the manufacturer's premises using robot-assisted production lines which are very largely automated, with the positioning of the sealing strip along the aforesaid sections being carried out in accordance with the data on the individual door frames or the other door structure which are stored in a CAD system or a comparable system.

DE 37 34 371 A1 discloses paneling which is suitable for automatic mounting and is intended for the bodywork of a vehicle in which paneling is provided with clamping webs which can be plugged into a channel which has an overall U shape and is connected to the vehicle door. The plugged-in state can be ensured by virtue of the fact that the accommodating profile is embodied in the form of a wedge or U-shaped rubber inserts can be placed in the accommodating profile. In all cases, a means of attachment which is designed in this way, for a paneling part, is intended for automatic mounting by an assembly robot which senses the outer contour of the paneling part. Sealing strips are known to form articles which are subject to wear and which have to be replaced during the usual service life of a vehicle or in the case of damage and replaced with new sealing strips. This replacement of sealing strips is usually carried out in relevant vehicle workshops which, however, do not have fabrication systems of the kind which are available to the manufacturers of motor vehicles, for example. This means that the positioning of the sealing strip along the periphery of, for example, a door, in accordance with predefined design data is a laborious and in particular time-consuming process which has to be carried out in accordance with manufacturers' specifications.

Against this background, the object of the invention is to configure a sealing arrangement of the type designated at the beginning with the stipulation that quick and in particular functionally appropriate replacement and re-insertion of sealing strips is possible in an extremely easy way, and therefore also under the operating conditions of customary servicing work. This object is achieved in a sealing arrangement of the type designated at the beginning by means of the features of the characterizing part of claim 1.

The sealing strip is provided with a plurality of aids which are intended and configured for interaction with stop elements of the frame structure. Such an aid forms an integral component of the sealing strip and has a captive connection to it in any case. The presence of this aid does not adversely affect the customary functions of the sealing strip in any way, however. A significant precondition is merely that the frame structure with which the aid interacts has structural features which are suitable as stop elements and which have a standardized profile along the periphery of the frame structure, and thus can carry out the function of reference marks by virtue of this property. This is usually the case. This means that the correct positioning of the sealing strip is indicated merely by the aid bearing against the aforesaid stop elements of the frame structure. Aids of this type can be provided along the entire periphery of the sealing strip, but the presence of these aids along just one part of the periphery can also be sufficient in many cases. The same applies to the aforesaid stop elements. The sealing strips are provided with grooves which permit them to be fitted onto frame parts, in particular the free edges of such parts. The invention makes use of this fact to place a limit on the insertion depth via which the groove is provided for the respective frame part which forms part of the frame structure, said limiting process being subject to the stipulation that the sealing strip is positioned precisely on the correct section of the frame structure when the maximum insertion depth is reached. The only precondition for this is that, owing to the geometric conditions, the insertion travel into the groove is suitable, by virtue of its arrangement, for influencing the positioning on the aforesaid section. The grooves of the sealing strip are known per se, and for limiting the insertion depth of such sealing strip transverse walls are provided which limit the depth of the groove or to use individually matched groove depths so that the precise position of the sealing strip can be derived in all cases from the bearing of the frame part in the bottom of the groove. A further form of such an aid is embodied by a bead which is provided on the outside of the sealing strip and has defined dimensions. It is intended to interact with a stop face of the frame structure so that the bearing of the sealing strip by means of this bead in turn indicates the precise position on the aforesaid section. Such a bead can extend along the entire length of the sealing strip, but it is also conceivable for the bead to be provided only along part of the entire length. The bead is connected to the sealing strip in a releasable, in particular tear-off connection. If the sealing strip is therefore placed in accordance with its reference position on the aforesaid section, a further function for the bead is eliminated so that the latter can easily be removed and discarded. The bead can basically be connected to the sealing strip at any desired location, and said sealing strip is decisively determined by the local geometric conditions of the frame structure.

In accordance with the features of claim 2, the bead is provided directly on the attachment section.

In order to facilitate removal of the bead from the attachment section, a web which connects the bead to the attachment section is provided in accordance with the features of claim 3. Said web is dimensioned with respect to the tearing off of the bead from the attachment section.

The features of claims 4 to 6 are aimed at the further configuration of the sealing section and of the attachment section, in particular its formation in terms of material. Accordingly, the sealing section on the one hand and the attachment section on the other are usually composed of different materials. While the sealing section is composed of a microcellular rubber, the attachment section can be constructed from a soft rubber. However, construction of the entire cross-sectional profile of the sealing strip in a homogeneous fashion in terms of material is not ruled out.

The bead is usually constructed using the same material as the part of the sealing profile on which it is integrally formed. Thus, according to the feature of claim 7, the bead is constructed using the same material as the attachment section and is connected thereto by means of a tear-off web which performs the function of a predetermined break point. This permits the bead to be conveniently torn off after it has performed its place-holding function.

According to the features of claim 8, the bead is usually configured to bear against a surface section, adjoining the section, of the frame structure, the attachment section being connected to said surface section. This surface section merely has to be provided with such an orientation in relation to the aforementioned section that it can be used for a stop function.

According to the features of claim 9, the attachment section is usually connected to the frame structure by means of a bonding layer. Virtually any desired techniques can be used within the scope of the bonding layer. These techniques are known to the person skilled in the art so that more details do not need to be given on them here.

It is apparent from the statements above that the sealing arrangement according to the invention permits uncomplicated and cost-effective mounting within the scope of servicing work, therefore outside computer-assisted operating sequences which are available at the manufacturer's premises and are very largely automated.

The invention is explained in more detail below with reference to the exemplary embodiment which is represented in the drawings, in which:

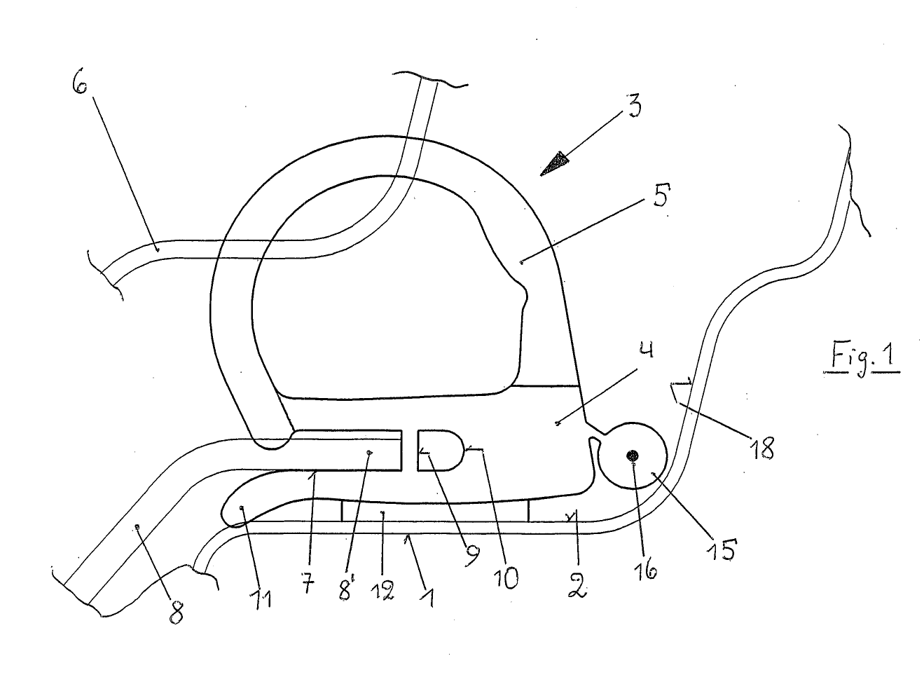

FIG. 1 is an illustration of a cross section of a sealing strip according to the invention in the installation state, and

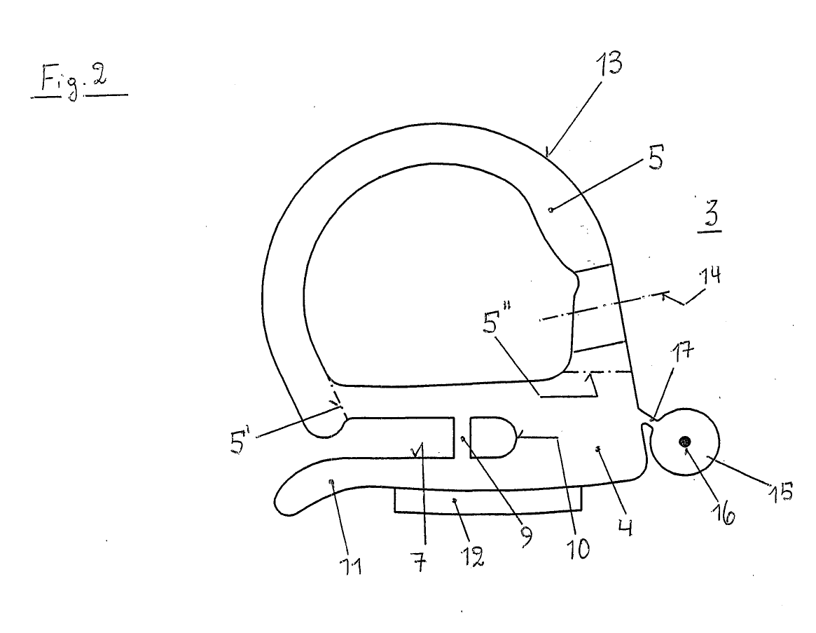

FIG. 2 is an enlarged cross-sectional illustration of a sealing strip according to the invention.

Part of the frame structure of a motor vehicle door which has a planar section 2 which is intended for the manufacture of a bonding connection to a sealing strip 3 is to signify 1. The section 2 extends along the entire outer periphery of the door and frequently has different widths in this direction, the profile of which, viewed in the direction of the aforesaid periphery, depending on the specific embodiment of the frame structure. In this regard it is essential that the positioning of the sealing strip 3 on the section 2 along the periphery is not uniform.

The sealing strip 3 is composed globally of an attachment section 4 which is intended for connection to the section 2, and of a hollow-profile-like sealing section 5 which is fitted onto the attachment section 4.

A corresponding profile of the vehicle opening, to close which the motor vehicle door mentioned above is intended and which forms the corresponding surface with which the sealing section 5 interacts in the closed state with elastic deformation according to the specification is designated by 6.

The attachment section 4 can be manufactured from a soft rubber, while the sealing section 5 is composed of microcellular rubber, for example with a Shore A hardness of approximately 40. The boundaries of the regions of the sealing strip which have different materials are designated by 5′ and 5″, respectively.

The sealing strip which is composed of the sections 4, 5 mentioned above can be manufactured in a manner known per se in a continuous method by means of the co-extrusion of the two sections.

The attachment section 4 is provided on its lefthand side in the drawing with a groove 7 which extends parallel to the section 2 and typically extends along the entire length of the sealing strip. The free end 8′ of a frame part 8 which extends along the entire periphery of the door, specifically at a distance from the facing side of the section 2 and extending parallel to it, is held in this groove 14. The frame part 4 is, for the rest, connected to the frame structure of the door in a way which is not illustrated in the drawing.

A transverse wall which bounds the insertion depth of the free end 8′ into the groove 7 and whose distance from the bottom 10 of the groove, viewed in the longitudinal direction of the sealing profile 3, is determined in accordance with functionally correct positioning of the sealing strip, specifically with adaptation to a specific embodiment of the door structure, is designated by 9.

A sealing lip which is integrally formed onto the attachment section 4 on its side facing the part 1 and which extends in the direction of said part 1 is designated by 11. In the installed state, it bears against the part 1 under elastic prestress.

For the rest, the attachment section 4 is connected to the section 2 by means of a bonding layer 12, a bonding strip or the like. It is apparent that the bonding layer 12 is arranged sealed with respect to the interior of the door frame structure by means of the sealing lip 11.

Functional elements in FIG. 2 which correspond to those in FIG. 1 have corresponding reference numerals so that it is possible to dispense with repeating the description in this respect.

The visible region 13 of the sealing strip which lies opposite the bonding layer 12 and which bears against the corresponding profile 6 in the closed state of the door is covered with a sliding coating agent (not illustrated in the drawing) in order to reduce friction which occurs.

A series of production-related ventilation openings which are arranged distributed in the longitudinal direction of the sealing strip is designated by 14.

A bead which is cylindrical in cross section, extends in the longitudinal direction of the sealing strip 3 and contains a thread 16 is designated by 15. This bead 15 is connected via a comparatively thin-walled web 17 to the attachment section 4, specifically to its righthand side, when viewed in the figures of the drawing, and opposite the groove 7.

The essential factor is that the bead 15 has, together with the web 17, defined dimensions in a direction parallel to the bonding surface 12 or the section 2. This fact is used to position the sealing strip 3 on the section 2 in a way which will be described below.

According to the invention, a positioning aid for the manual mounting of the sealing strip 3 is then provided by the placing of the transverse wall 9, viewed in the direction of the depth of the groove 7. This groove 7 continuously interacts with the frame part 8, in particular its free end 8′, use being made of the fact that the frame part 8 assumes a standardized position along the entire periphery, or else part of the periphery, of the motor vehicle door. This provides the possibility of performing the positioning of the sealing strip 3 with the stipulation that its position is defined on the basis of that of the frame part 8.

This is done by virtue of the fact that the maximum insertion depth of the groove 7, specifically the dimension by which the frame part 8 can be inserted into the groove 7, viewed in the longitudinal direction of the sealing strip 3, is defined structurally by corresponding placing of the transverse wall 9. Functionally correct positioning of the sealing strip is therefore indicated by the free end of the frame part 8 bearing against the transverse wall 9.

The method of operation above is provided on those regions of the periphery on which a frame part 8 of the type described above is available. The bonding can then be performed with the section 2.

If the latter is the case, the sealing strip is therefore correctly positioned and can be bonded to the section 2.

The procedure adopted at points on the periphery of the frame structure at which the frame part 8 is not available, so that it is not possible to position using the groove 7, is such that the sealing strip 3 is placed on the section 2 with the stipulation that the bead 15 bears against a surface section 18 of the frame structure. This surface section 18 is, as shown in FIG. 1, bent with respect to the section 2 and is used according to the invention as a bearing face.

Functionally correct positioning of the sealing strip 3 is therefore likewise indicated by bearing of the bead 15 against the surface section 18.

After bonding to the section 2 has been carried out, the bead 15 is separated from the sealing strip 3.

In this way, the functionally correct mounting of a sealing strip on a motor vehicle door is possible when necessary in a manual way without particular aids or complex measurements, and in particular without a special tool.

1. A sealing arrangement having a sealing strip (3) which is configured for use on the frame structure of a vehicle opening or of a door which interacts with said vehicle opening, comprising an attachment section (4) which is intended for direct connection to a section (2) of the frame structure, and a sealing section (5) which is fitted onto the attachment section (4) and is intended to interact with a corresponding profile (6) of the door or of the edge, having a groove (7) which is configured to receive the free end (8′) of a frame part (8) of the frame structure, which groove extends along at least part of the entire length of the sealing strip (3), characterized in that the insertion depth of the groove (7) is limited in accordance with the positioning of the sealing strip (3) on the section (2), and in that a bead (1 5) is provided which performs the function of a spacing element, extends along at least part of the length of said sealing strip and has a releasable, in particular tear-off connection to the sealing arrangement.

2. The sealing arrangement as claimed in claim 1, characterized in that the bead (15) is connected to the attachment section (4).

3. The sealing arrangement as claimed in claim 1, characterized in that the bead (15) is connected via a web (17) to the attachment section (4) in a tear-off connection thereto.

4. The sealing arrangement as claimed in claim 1, characterized in that the sealing section (5) is embodied as a hollow profile.

5. The sealing arrangement as claimed in claim 1, characterized in that the sealing section (5) is composed of a microcellular rubber.

6. The sealing arrangement as claimed in claim 1, characterized in that the attachment section (4) is composed of a soft rubber.

7. The sealing arrangement as claimed in claim 1, characterized in that the bead (15) is constructed using the same material as the attachment section (4) and is connected thereto by means of a tear-off web (17).

8. The sealing arrangement as claimed in claim 1, characterized in that the bead (15) is configured to bear against a surface section (1 8), adjoining the section (2), of the frame structure.

9. The sealing section as claimed in claim 1, characterized by a bonding layer (12) by means of which there is connection to a section (2).

10. The sealing arrangement as claimed in claim 1, characterized by a sealing lip (11) which is integrally formed onto the attachment section (4) and is intended to bear against the section (2) or an adjoining part of the frame structure.

11. The sealing arrangement as claimed in claim 1, characterized by a sealing strip (3) which is available as a continuous product and is provided with a groove (7) and a bead (15) over its entire length.

12. The sealing arrangement as claimed in claim 2, characterized in that the bead (15) is connected via a web (17) to the attachment section (4) in a tear-off connection thereto.

13. The sealing arrangement as claimed in claim 2, characterized in that the sealing section (5) is embodied as a hollow profile.

14. The sealing arrangement as claimed in claim 2, characterized in that the sealing section (5) is composed of a microcellular rubber.

15. The sealing arrangement as claimed in claim 2, characterized in that the attachment section (4) is composed of a soft rubber.

16. The sealing arrangement as claimed in claim 2, characterized in that the bead (15) is constructed using the same material as the attachment section (4) and is connected thereto by means of a tear-off web (17).

17. The sealing arrangement as claimed in claim 2, characterized in that the bead (15) is configured to bear against a surface section (1 8), adjoining the section (2), of the frame structure.

18. The sealing section as claimed in claim 2, characterized by a bonding layer (12) by means of which there is connection to a section (2).

19. The sealing arrangement as claimed in claim 2, characterized by a sealing lip (11) which is integrally formed onto the attachment section (4) and is intended to bear against the section (2) or an adjoining part of the frame structure.

20. The sealing arrangement as claimed in claim 2, characterized by a sealing strip (3) which is available as a continuous product and is provided with a groove (7) and a bead (15) over its entire length.
